(19) United States
(12) Patent Application Publication
(10) Pub. No.: US 2025/0033422 A1
(43) Pub. Date: Jan. 30, 2025

(54) TIMING CONTROL IN A TIRE PRESSURE MONITORING SYSTEM

(71) Applicant: Sensata Technologies, Inc., Attleboro, MA (US)

(72) Inventors: Samuel K. Strahan, Ballymena (GB); William D. Stewart, Antrim (GB)

(73) Assignee: Sensata Technologies, Inc., Attleboro, MA (US)

(21) Appl. No.: 18/760,540

(22) PCT Filed: Dec. 20, 2022
(86) PCT No.: PCT/US2022/053528

§ 371 Date: Jul. 1, 2024

Related U.S. Application Data
(60) Provisional application No. 63/296,375, filed on Jan. 4, 2022.

(51) Int. Cl. B60C 23/04; H04B 17/318

(52) U.S. Cl. CPC B60C 23/0416; B60C 23/0422; H04B 17/318

(57) ABSTRACT

A system and method determine and/or adjust tire pressure sensor timings to transmit information using BLE information, regardless of the presence of other BLE systems. A tire pressure monitoring (TPM) system or other computing device receives transmission timing information from tire monitors that transmit using BLE and/or other BLE-enabled components. In response to determining an interference between the transmissions of the tire monitors and/or the components, timing of the transmissions from one or more of the tire monitors is altered to avoid the interference.

### CROSS-REFERENCE TO RELATED APPLICATIONS

This application claims the benefit of priority to U.S. Provisional Patent Application No. 63/296,375, titled “Avoiding Clashing in a TPM System,” and filed Jan. 4, 2022. The '375 application is hereby incorporated by reference in its entirety.

### FIELD OF THE TECHNOLOGY

The subject disclosure relates to tire pressure monitoring systems, and more particularly to avoiding signal clashing between tire pressure monitoring systems and other vehicle Bluetooth Low Energy transmitters.

### BACKGROUND OF TECHNOLOGY

A conventional direct tire pressure monitoring (TPM) system monitors and reports tire pressure measurements and/or other attributes of a vehicle. Additionally, TPM system sensors that are mounted on a vehicle typically communicate to a receiver on the vehicle through radio frequency (RF) while, more specifically, utilizing Ultra High Frequency (UHF) communication technology. However, there has been a growing trend in the TPM system industry to move from RF technology to Bluetooth Low Energy (BLE) technology. This may be advantageous as BLE technology allows for bidirectional communication, in other words, sensors using BLE technology may be capable of both receiving and transmitting information. In addition to TPM systems migrating to BLE, other onboard vehicle systems also are being configured to leverage advantages associated with BLE. However, multiple components operating over BLE may reduce available bandwidth, potentially compromising the flow of important information. Many systems operate in the background to ensure that they are initialized and operative, which may entail a significant consumption and/or competition of and/or for the available BLE bandwidth at various times. Thus, there is a need in the art for TPM systems that can transmit information using BLE information, regardless of the presence of other BLE systems.

### SUMMARY OF THE TECHNOLOGY

In light of the needs described above, in at least one aspect, the subject technology relates to improved TPM systems and methods of using such systems. For example, aspects of this disclosure can be used to adjust TPM sensor transmission timings based upon a variety of variables, including but not limited to, competition with other onboard BLE systems, close timing proximities between TPM sensors associated with other tires, timing changes to onboard BLE systems, e.g., resulting from Over the Air (OTA) update technology, assignment of transmission time slots when made available, and/or adjusting transmission timing for the TPM sensors to compensate for clock drift within components.

### BRIEF DESCRIPTION OF THE DRAWINGS

So that those having ordinary skill in the art to which the disclosed systems and techniques pertain will more readily understand how to make and use the same, reference may be had to the following drawings.

FIG. 1 is a schematic representation of a vehicle including tire pressure monitors, a representation of an onboard component, and a tire pressure monitoring control module, in accordance with aspects of this disclosure.

FIG. 2 is a schematic representation of a timing scheme for data transmission from tire monitors and/or other computing systems of a vehicle, in accordance with aspects of this disclosure.

FIG. 3 is a schematic representation of an example of an improved timing scheme for data transmission from tire monitors and/or other computing systems of a vehicle, in accordance with aspects of this disclosure.

FIG. 4 is a flowchart illustrating an example process for adjusting data transmission times in vehicles, in accordance with aspects of this disclosure.

### DETAILED DESCRIPTION

The subject technology overcomes many of the prior art problems associated with tire pressure sensor transmission timing in vehicles. In brief summary, the subject technology provides tire monitoring systems that allow for bidirectional communication with other onboard systems and techniques for controlling data transmission of such systems (and/or additional systems) to avoid transmission clashing and/or free up BLE bandwidth. The advantages, and other features of the systems and methods disclosed herein, will become more readily apparent to those having ordinary skill in the art from the following detailed description of certain preferred embodiments taken in conjunction with the drawings, which set forth representative examples of the present disclosure.

In implementations of this disclosure, a vehicle can include a tire pressure monitoring system. The tire pressure monitoring system can include a plurality of tire monitors, e.g., one monitor per tire of the vehicle, and one or more computing systems for receiving data from and transmitting data to the tire monitors. In aspects of this disclosure, the tire monitors may be configured for bidirectional communication, e.g., using a data transmission protocol such as Bluetooth Low Energy (BLE). Although examples of this disclosure are made with reference to the use of BLE for data transmission, other high-frequency, bidirectional communication protocols may be used.

In aspects of this disclosure, one or more additional computing devices may be associated with the vehicle. Such computing device(s) may also be configured to transmit and/or receive data, e.g., using BLE. Examples of such computing device(s) can include onboard computing systems, user-associated devices, e.g., personal electronics or key fobs, and/or the like. Without limitation, components of the vehicle may be configured to be updated via over the air (OTA) technologies. Transmissions from the additional computing device(s), in combination with transmissions from the tire monitors, can result in severe reduction in bandwidth, which may severely hinder transmission of data.

Aspects of this disclosure can include receiving timing information from the tire monitors and/or other computing devices and manipulating transmission timings to reduce the impact on bandwidth. For example, in instances of this disclosure, each of the tire monitors may transmit to a computing system timing information associated with times at which the tire monitor transmits a pressure measurement or similar data about the tire with which the tire monitor is associated. In examples, the timing information may include information about a period at which the data is transmitted, as well as a time at which one or more transmissions was/were made. Without limitation, the time may be determined based at least in part on a clock, a timestamp, and/or the like. As will be appreciated, the tire monitors may all be configured to transmit data according to the same period. The techniques described herein can also include receiving timing information from other computing devices. In examples, timing information may be received for any device that may be transmitting using the same communication protocols, e.g., BLE or the like.

Aspects of this disclosure can also determine an interference between transmissions of two or more of the tire monitors and/or the additional computing devices. For example, the interference may be an actual interference, e.g., occurring when multiple sensors are attempting to transmit at the same time, or a potential interference, which may occur when multiple sensors are tempting to transmit at times that are relatively close. In some examples, because the tire monitors and/or the additional computing devices are transmitting via the same communication protocol, transmissions at the same time, or in close time proximity, may lead to reduced bandwidth, which can result in degraded data, latency issues, and/or the like. In some examples, reduced bandwidth can result in some information failing to be received at an intended destination. In the context of tire monitors, the reduced bandwidth may prevent a driver from timely receiving information about a tire pressure anomaly.

Also in aspects of this disclosure, in response to determining an interference between transmissions of two or more of the tire monitors, the techniques are described herein can include determining adjusted timing parameters. For example, the techniques described herein may determine a time an updated or alternate time at which one or more of the tire monitors and/or the additional computing devices will transmit data. In some examples, the adjusted timing parameters may be determined to maximize the time between transmissions of data. In further examples, the adjusting time parameters may be determined to reduce an impact on available bandwidth.

Aspects of this disclosure can also include causing one or more of the tire monitors and/or the computing systems to alter a transmission time of data from the respective monitor/system. For example, the tire monitors according to aspects of this disclosure may be configurable such that they can receive instructions to transmit data at a specific time, and continue to transmit data according to some predetermined period, e.g., at a predetermined frequency. In examples, because the tire monitors are configured to communicate via a bidirectional communication protocol, such as BLE, in addition to transmitting pressure and/or any other information, the tire monitors may also be configured to receive instructions for configuring aspects of the tire monitors.

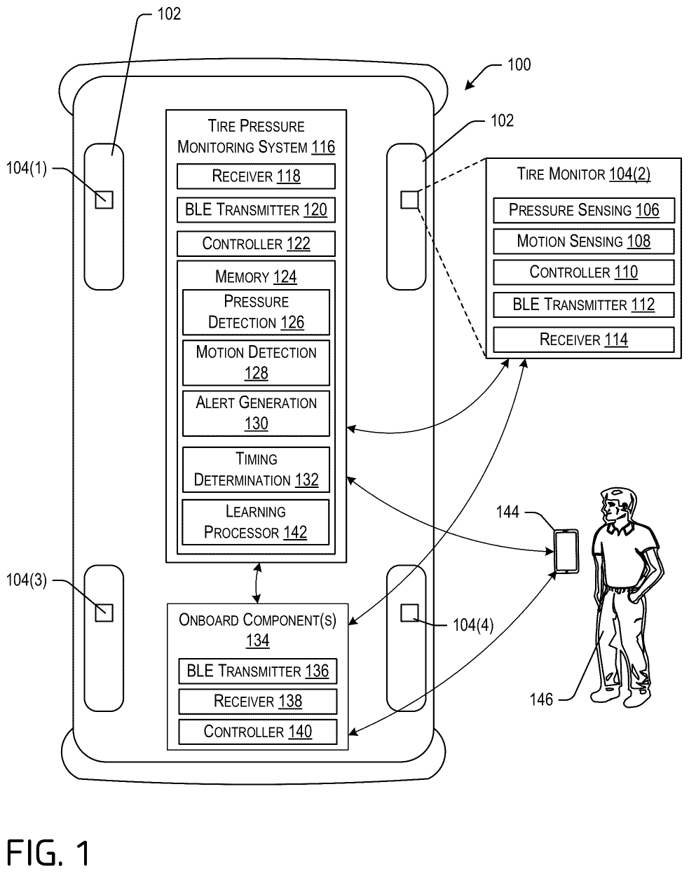

As a result of the improved systems and techniques disclosed herein, tire monitors and/or a number of other device(s) can be configured to communicate using a high frequency, bidirectional communication protocol with reduced impact on available bandwidth. The techniques and systems described herein can provide robust data transfer, overcoming draw backs of conventional tire monitor systems. These and other features and benefits of this disclosure will be discussed with reference to FIG. 1-4, below.

FIG. 1 illustrates a vehicle 100 including a number of tires 102 and a plurality of tire monitors 104(1)-104(4) (collectively referred to herein as “the tire monitors 104”) associated with the tires 102. For example, each of the tires 102 can have an associated one of the tire monitors 104. The tire monitors 104 may be coupled to the tires 102, e.g., via a tire mount, a valve mount, or the like. According to aspects of this disclosure, the tire monitors 104 can also include, among other features, a pressure sensing component 106, a motion sensing component 108, a controller 110, a BLE transmitter 112, and a receiver 114. Although not illustrated in FIG. 1, each of the tire monitors 104 may also include one or more power sources, e.g., batteries, and/or other conventionally-known components. Although the pressure sensing component 106, the motion sensing component 108, the controller 110, the BLE transmitter 112, and the receiver 114 are illustrated as separate components, functions associated with two or more of the components may be combined into a single computing module or computing component.

The pressure sensing component 106 is configured to generate a signal indicating a measured pressure associated with the tire 102. The pressure sensing component 106 may generate the pressure signal at a predetermined time, e.g., according to a sampling rate or the like. Aspects of the pressure sensing component 106 may be configurable. For example, the sampling rate may be altered. Moreover, a time at which one or more of the samples is taken may be specified. In accordance with examples described herein, pressure sampling times and/or rates may be modified based on data transmission times, e.g., such that data is sampled in close proximity to the data being transmitted from the monitor 104.

The motion sensing component 108 is configured to generate information associated with motion of the tire 102. For example, the motion sensing component 108 can include an inertial motion unit, a resolver, a rotary sensor, a position sensor, or the like. The motion sensing component 108 can generate motion data at a predetermined rate. In examples of this disclosure, data from the motion sensing component 108 can be used to determine when a tire (and therefore a vehicle) is stationary and/or when the tire/vehicle is in motion. Moreover, in some examples, the motion sensing component 108 is configurable. e.g., to generate and output motion data at different sampling rates and/or in response to certain conditions. In some instances, the motion sensing component 108 can determine a location of the tire monitor 104, and thus the associated tire 102, on the vehicle 100. Although the tire monitors 104 are illustrated as including the motion sensing component 108, in other examples the tire monitors 104 may not have the motion sensing component. For example, motion may be detected via one or more sensors disposed elsewhere on the vehicle, e.g., other than on the tire monitors 104.

The controller 110 may be configured to control aspects of the tire monitor 104. For instance, and without limitation, the controller 110 can control sampling rates of the pressure sensing component 106 and/or of the motion sensing component 108. Moreover, the controller 110 can include functionality to generate signals, e.g., corresponding to tire pressure anomalies, tire movement, or the like. The controller 110 can also include functionality to cause the signals to be transmitted from the tire monitor 104 and/or to control a timing of transmission of those signals. Stated differently, the controller 110 can control the timing of transmission of data from the tire monitor. In examples described herein, the transmission timing may be adjusted to avoid bandwidth competition with one or more other components transmitting via BLE or other signals (e.g., one or more onboard components 134 and/or one or more remote devices 144).

The BLE transmitter 112 may be configured to send information, e.g., signals associated with pressure information generated by the pressure sensing component 106, motion information generated by the motion sensing component 108, information generated by the controller 110, and/or other information. As noted above, the BLE transmitter 112 can be configured to control the timing of information transmission. In some examples, the adjustment of timing can include implementing delays, offsetting timings, expediting sending, and/or reconfiguring timing schedules. Also in examples, the BLE transmitter 112 can be configured to send a signal, e.g., to a vehicle computing system, to alert the vehicle to a transmission timing clash. In examples, the BLE transmitter 112 can be adapted to transmit data according to conventional BLE protocols. Although examples of this disclosure may be particularly directed to tire monitors and other vehicle components using BLE transmission, implementations described herein can also be applied to other high-frequency, bidirectional communication protocols, such as Bluetooth, ultra-wideband, or the like.

The receiver 114 may be configured to receive information from a remote source. For instance, the receiver 114 may be configured to receive instructions from one or more additional onboard components 134 on the vehicle 100 and/or remote from the vehicle 100. Without limitation, the receiver 114 may be configured to receive requests to generate and/or transmit data associated with pressure and/or motion. The receiver 114 may also be configured to receive commands to alter timing protocols associated with the BLE transmitter 112. The receiver 114 can be adapted to receive data according to any of a number of conventional protocols. Although shown as separate components, the BLE transmitter 112 and the receiver 114 may be embodied as a single component in other examples, e.g., as a BLE transceiver.

As illustrated in FIG. 1, the vehicle 100 also includes a tire pressure monitoring system 116. Although shown as separate from the tire monitors 104, in some examples, components and/or functionality of the tire monitor 104 and the tire pressure monitoring system 116 may be part of a single system. Without limitation, some of the functionality ascribed above to aspects of the tire monitor 104, including the controller 110, may be performed at the tire pressure monitoring system 116. As shown in FIG. 1, the tire pressure monitoring system 116 includes a receiver 118, a BLE transmitter 120, a controller 122, and memory 124. The memory 124 can include a pressure detection component 126, a motion detection component 128, an alert generation component 130, and/or a timing determination component 132.

The receiver 118 may be configured to receive transmissions from the BLE transmitter 112. For instance, the receiver 118 can receive pressure information and/or motion information from the tire monitors 104. The receiver 118 can also be configured to receive a wake signal and/or other information. The receiver 118 can also be configured to receive transmissions from other components, e.g., onboard components 134, remote components, or the like. For instance, the receiver 118 can receive information associated with transmission timings associated with the onboard components 134, information associated with transmission timings associated with the tire monitors 104, pressure and/or motion information from the tire monitors, or the like. The receiver 118 can be adapted to receive data according to any of a number of conventional protocols, include BLE.

The BLE transmitter 120 of the tire pressure monitor system 116 may be configured to transmit data from the tire pressure monitoring system 116. For instance, the BLE transmitter 120 can transmit data to the tire monitor 104, e.g., to instruct transmission timing adjustments, to request information, to instruct a reconfiguration such as a modified sampling rate, or the like. The BLE transmitter 120 can also be configured to transmit data to other electronic devices, e.g., the onboard component 134, a remote device 144, which may be associated with a user 146, which may be an owner of the vehicle 100, to a display of the vehicle 100, or the like. Although the receiver 118 and the BLE transmitter 120 are illustrated as separate components, in examples these components may be embodied as a single transceiver.

The controller 122 may be configured to perform actions according to aspects of this disclosure. Without limitation, the controller 122 can be configured to generate instructions, alerts, or other commands. For example, the controller can be configured to perform acts associated with components stored in the memory 124 and/or to perform operations of the processes 400 discussed below.

The pressure detection component 126 includes functionality to determine tire pressure anomalies. Although shown as part of the tire pressure monitoring system 116, functionality associated with the pressure detection component 126 can be implemented at the tire monitor 104, e.g., at the pressure sensing component 106 or some other data processing component. The pressure detection component 126 includes functionality to determine a pressure of the tire 102. In examples, the pressure detection component 126 can also compare a sampled pressure to one or more pressure thresholds. For example, the pressure detection component 126 can include functionality to determine whether a tire pressure is within a normal operating pressure range or whether the tire pressure is outside the normal operating range. In the latter case, the pressure detection component 126 can determine that a tire pressure is anomalous. The pressure detection component 126 can also generate instructions to cause the pressure sensing component 106 to alter a sampling rate, e.g., a rate at which the pressure sensing component 106 determines a pressure of the tire 102. For instance, the pressure detection component 126 can cause the pressure sensing component 106 to determine a pressure of the tire 102 at a first rate when the vehicle 100 is moving and at a second rate when the vehicle is stationary

The motion detection component 128 can include functionality to determine that the vehicle 100 is moving, has begun to move, or is about to move. For instance, when a vehicle begins to move, several components on the vehicle, including the tire monitors 104 and additional components, begin to transmit information, e.g., via BLE transmission. Aspects of this disclosure may be particularly suited to adjusting timing of transmissions from BLE transmitters associated with various devices to minimize interference, and such timing may be beneficially adjusted at vehicle travel initialization.

The alert generation component 130 can include functionality to generate alerts. In examples described herein, alerts can be generated and transmitted to a driver of the vehicle 100, e.g., via on-vehicle displays, haptic feedback elements, or the like. Also in examples, the alerts can be transmitted to an electronic device associated with the vehicle 100. For example, the alert generation component 130 can generate an alert to be transmitted, e.g., via the BLE transmitter 120, to a smart phone, laptop, tablet, wearable, or any other device capable of receiving and/or presenting an alert.

The timing determination component 132 can include functionality to receive, store, and/or generate and/or to adjust transmission timings for various components, including the tire monitors 104, as detailed herein. For instance, the timing determination component 132 may include functionality to receive information about a plurality of components transmitting using BLE, including the tire monitors 104, components on the vehicle 100, and/or components remote from the vehicle 100. For example, the timing determination component 132 can include timing information associated with transmissions from the tire monitors, including times at which transmissions are made, durations of transmissions, and/or the like. In at least some examples, the timing determination component 132 can determine the timing information based at least in part on timestamps, metadata, and/or tags associated with transmitted data. Similarly, the timing determination component can receive timing information associated with transmissions from the onboard components 134, the remote components 144, and/or other devices. In examples, the timing determination component 132 can also receive. e.g., as or with the timing information, information about the data transmitted. For example, the timing determination component can receive information associated with a size of data received (e.g., a file or packet size), a criticality or importance associated with the data received, and/or other data.

The timing determination component 132 can also include functionality to identify potential or actual interferences associated with data transmissions. For example, the timing determination component 132 can compare transmission timings for transmissions from multiple transmitters to determine whether two or more timings are within a threshold time of each other. For example, when transmission timings are the same, or substantially the same, there may be a high likelihood of interference between the transmissions. Alternatively, or additionally, the interfering transmissions may significantly reduce available bandwidth. Reductions in bandwidth can increase latency of data transfer, may prevent critical information from being transmitted in a timely manner via the communication protocol, and/or have other adverse implications.

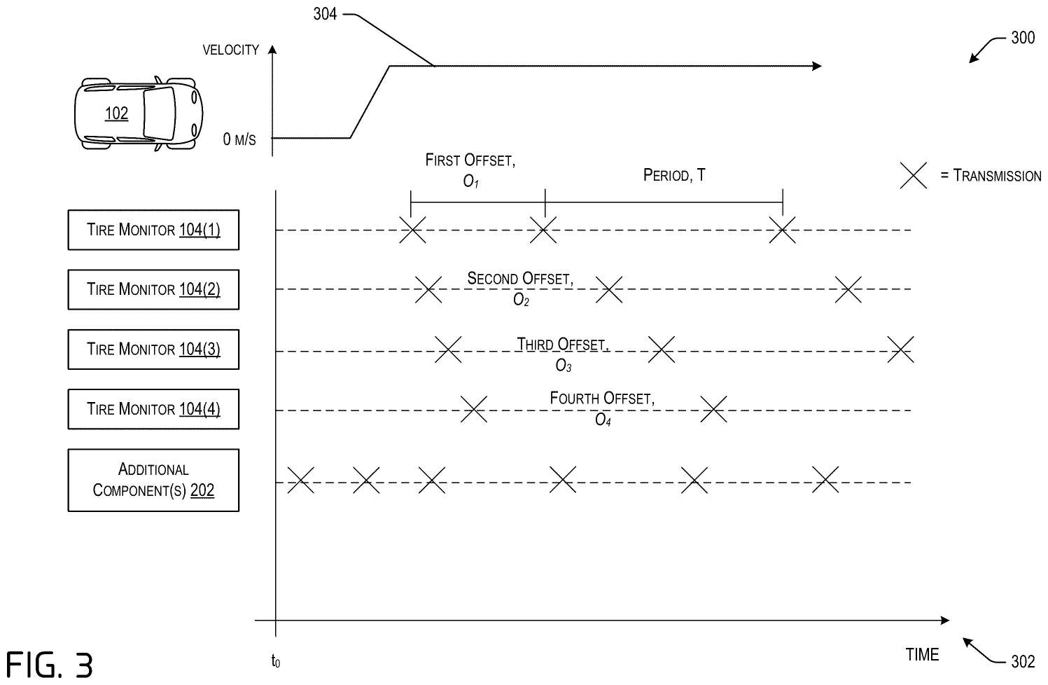

The timing determination component 132 can also include functionality to determine, based at least in part on identifying an interference between transmission timings, altered timing parameters. For example, the altered timing parameters may be associated with times at which the tire monitors 104 and/or other components transmitting using the same communication protocol, can transmit information to reduce or eliminate interference. In examples, the altered timing parameters can include one or more offsets to be implemented by the tire monitors 104 to adjust timing parameters. For example, and as discussed further below; e.g., in connection with FIG. 3, tire monitors may be configured to implement an offset, e.g., to delay one or more transmissions, to expedite one or more transmissions, and/or otherwise alter a timing of one or more transmissions. In some examples, the timing determination component 132 can determine new timings for the tire monitors 104 and/or other components, to maximize a time between transmissions. For example, the timing determination component 132 can receive information from the four tire monitors 104 that indicates that the transmissions of the sensor are only offset by one second. The timing determination component 132 can also receive timing information that indicates that the monitors are configured to transmit pressure data at a frequency of one transmission every thirty seconds. With this information, the timing determination component may instruct the monitors to offset their next transmission. e.g., such that there is approximately a 7.5 second interval between transmissions. After the initial offset, the tire monitors will transmit a new signal every 30 seconds, such that subsequent transmission are spaced at least about 7.5 seconds from other transmissions from other of the tire monitors 104. The timings may also be based at least in part on timing information for transmissions from other components.

The timing determination component 132 can also use additional information to determine the altered timing parameters. For example, as noted above, the timing determination component 132 can also receive information about the amount of transmitted data. The timing determination component 132 can also receive or determination information about a bandwidth or available bandwidth. In examples, the timing determination component 132 can determine to allow for timings that may be close in time, but the amount of data transferred in the two (or more) transmissions may be below some threshold amount. The timing determination component 132 may also include functionality to monitor bandwidth and generate instructions for the tire monitors 104 to transmit during appropriate bandwidth levels. Also, in examples, the timing determination component 132 can receive internal clock data from the tire monitors 104 adjust the 104 timing of the tire monitors 104 to compensate for clock drift. In some examples, the timing determination component 132 can include a learning processor 142, which may use one or more of machine learning, iterative computation, algorithmic modeling, artificial intelligence, and/or the like, to generate the altered timing parameters.

The timing determination component 132 can also include functionality to transmit data associated with the altered timing parameters to the respective components. In examples described herein, the timing determinations, e.g., as instructed transmission timings, transmission offsets, or the like, can be transmitted to the tire monitors 104. e.g., via the BLE transmitter 120.

Although the timing determination component 132 is illustrated as being a component of the tire pressure monitoring system, in other instances, functionality of the timing determination component 132 can be implemented on other components. Without limitation, functionality of the timing determination component 132 may be carried out at one of the tire monitors 104, one of the onboard component(s) 134, and/or at some other computing system or device.

As illustrated in FIG. 1, the vehicle 100 also includes the onboard components 134. The onboard component(s) 134 can also include, among other features, a BLE transmitter 136, a receiver 138, and a controller 140. In examples described herein, the onboard components 134 can be any components configured to transmit data to and/or receive data from other components, including but not limited to the tire pressure monitoring system 116, the tire monitors 104, remote computing devices 142 (e.g., personal computing devices, mobile devices, maintenance computing devices, etc.), and/or other devices. The onboard component(s) 134 can be configured to transmit/receive data via BLE protocols. Without limitation, the onboard component(s) 134 can communicate data to the tire pressure monitoring system 116 and can receive instructions for altering transmission timings from the tire pressure monitoring system 116. As noted above, the timing determination component 132 can include functionality to determine transmission timings for the tire monitors 104 and/or the onboard component(s) 134. In other examples, one or more of the onboard component(s) 134 can include the functionality of the timing determination component 132. Also, in examples, the onboard components 134 may communicate directly with the respective tire monitors 104.

FIG. 1 also illustrates a user 146 proximate the vehicle 100. The user 146 may be a driver of the vehicle 100, for example. The user 146 is illustrated as having or being otherwise associated with, the remote device 144. The remote device 144 may be a personal electronic device, such as a phone, tablet, laptop, or the like. In other examples, the remote device 144 may be a key fob, a smart key, or the like. As will be appreciated, the remote device 144 may be configured to transmit via BLE, and thus the techniques disclosed herein may be useful to adjust transmission timings of the remote device, and/or to adjust transmission timings of other components, like the tire monitors 104, based at least in part on the transmissions from the remote device 144.

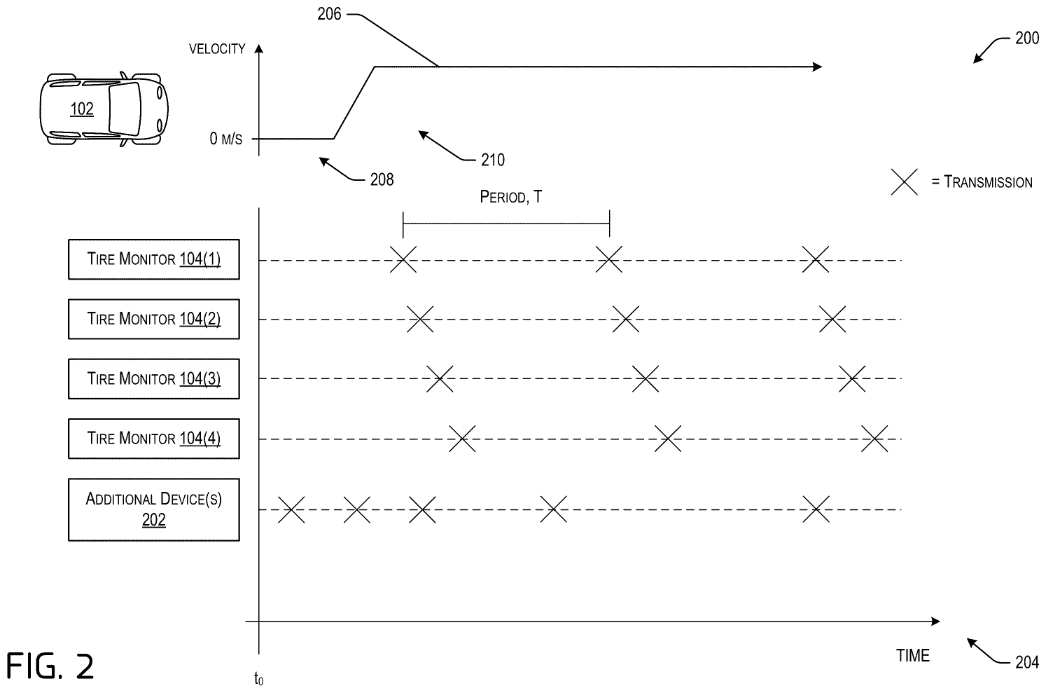

FIG. 2 is a schematic representation 200 demonstrating a conventional timing scheme for transmission of data associated with the vehicle 100. More specifically, the representation shows components of the vehicle 100 that may be configured to transmit data via a communication protocol such as BLE. The components are illustrated as including a plurality of tire monitors, e.g., the tire monitors 104(1)-104(4), as well as one or more additional devices 202. The additional devices may be the onboard component(s) 134, the remote device 144, and/or any other component, device, or system that can communicate via the same communication protocol, e.g., BLE, as the tire monitors 104. The representation 200 also includes a timeline 204, and a plurality of “X”s arranged along the timeline. Each X represents an individual transmission from the respective monitor/component. Thus, each of the first tire monitor 104(1), the second tire monitor 104(2), the third tire monitor 104(3), and the fourth tire monitor 104(4) is indicated as having three instances of transmission, which may correspond to instances of pressure information being transmitted from the respective tire monitors 104.

FIG. 2 also includes a velocity or speed profile 206 representing movement of the vehicle 100. Specifically, the vehicle starts from a zero-velocity state at an initial time to. For instance, the vehicle at an initial time, to, may be parked, turned off, or otherwise disengaged. The velocity profile 206 also illustrates that, at some time, the vehicle begins to move, e.g., as represented by the non-zero velocity. In some examples, in the time between the initial time to and commencement of movement, e.g., during a stationary state 208, the vehicle 100 may be started and one or more systems may be initialized or otherwise prepared for operation of the vehicle 100.

During the traditional timing scheme illustrated in FIG. 2, none of the tire monitors 104 is transmitting during the stationary state 208. Instead, each of the tire monitors 104 is configured to commence transmission upon movement of the vehicle (or the respective tire). For example, the motion sensors 108 in the tire monitors 104 would detect when the vehicle 100 has moved from the stationary state 208 into a driving state 210. Upon sensing the vehicle 100 has entered the driving state 210, the tire monitors 104 begin transmitting. As shown, an initial transmission from each of the tire monitors 104 begins shortly after commencement of the driving state 220, and the tire monitors 104 are then configured to send updated pressure signals, e.g., at a predetermined frequency. The example illustrates a period, T, between instances of the transmissions from each of the tire monitors. In typical examples, the tire monitors 104 may be configured such that the period T is 30 seconds, one minute, or some other amount of time. Moreover, and as illustrated, the initial transmission from each of the tire monitors 104 may be offset slightly. For example, some conventional tire monitors may be configured to, e.g., upon entering an active state, initiate transmission after some random delay. Without limitation, the random delay may be used to space transmissions from the tire monitors. Although the delays may be random, in practice there is a tendency for the transmissions of to be proximate each other in time. For example, it may be desirable to get pressure data as soon as possible after a vehicle commences movement, e.g., to quickly alert a driver to pressure anomalies. Thus, although a time delay may be applied to the initial transmission, the time delay may be relatively short, which may result in interference between transmissions.

As also illustrated in FIG. 2, the additional devices 202 can also be transmitting data. As shown, the additional devices 202 may have an increased transmission frequency during the stationary state 206. For instance, during the time when the driver is approaching the vehicle and moving off, e.g., during the stationary state 208 numerous systems may be working in the background to ensure that they are initialized and operative upon startup of the vehicle 100. This can mean that a lot of BLE-related RF traffic can occur in a short period of time, e.g., proximate a time at which the vehicle 100 begins moving. These BLE systems will be competing for bandwidth during this time, and at other times as well. For example, a vehicle with a pressure on demand system may be trying to establish contact with all four TPM system sensors, e.g., the tire monitors 104, as well as other onboard components 134, fitted to the vehicle. At the same time, the vehicle access system may be trying to locate the driver in relation to the vehicle 100, e.g., via communication with a user device. Furthermore, the competition for bandwidth will continue throughout the operation of the vehicle 100 since the intervals for all the tire monitors 104 remain the same.

While interference between two of the tire monitors may be tolerable in some instances, as an increased number of components and systems continue to migrate to bidirectional communication protocols, bandwidth may become more and more scarce. Accordingly, aspects of this disclosure include reducing a likelihood of, or substantially preventing, interference caused by multiple concurrent and/or proximate-in-time transmissions.

FIG. 3 is a schematic representation 300 of an improved timing scheme developed according to the techniques described herein. Specifically, like the representation 200, the representation 300 shows components of the vehicle 100 that may be configured to transmit data via a communication protocol such as BLE. The components are illustrated as including a plurality of tire monitors, e.g., the tire monitors 104(1)-104(4), as well as the additional devices 202, e.g., which may be the onboard component(s) 134, the remote device 144, and/or the like. The representation 300 also includes a timeline 302, and a plurality of “X”s arranged along the timeline. Each X represents an individual transmission from the respective monitor/component. Thus, each of the first tire monitor 104(1), the second tire monitor 104(2), the third tire monitor 104(3), and the fourth tire monitor 104(4) is indicated as having multiple instances of transmission, which may correspond to instances of pressure information being transmitted from the respective tire monitors 104.

Like FIG. 2, FIG. 3 also includes a velocity or speed profile 304 representing movement of the vehicle 100. Specifically, the vehicle starts from a zero-velocity state at an initial time to. For instance, the vehicle at an initial time, to, may be parked, turned off, or otherwise disengaged. The velocity profile 304 also illustrates that, at some time, the vehicle begins to move, e.g., as represented by the non-zero velocity. In some examples, in the time between the initial time to and commencement of movement, e.g., during a stationary state 306, the vehicle 100 may be started and one or more systems may be initialized or otherwise prepared for operation of the vehicle 100.

As with the traditional timing scheme illustrated in FIG. 2, none of the tire monitors 104 is transmitting during the stationary state 306. Instead, each of the tire monitors 104 is configured to commence transmission upon movement of the vehicle (or the respective tire). For example, the motion sensors 108 in the tire monitors 104 would detect when the vehicle 100 has moved from the stationary state 208 into a driving state 210. Upon sensing the vehicle 100 has entered the driving state 210, the tire monitors 104 begin transmitting. As shown, an initial transmission from each of the tire monitors 104 begins shortly after commencement of the driving state 220, and the tire monitors 104 are then configured to send updated pressure signals. In the example of FIG. 2 discussed above, after the initial transmission, each of the tire monitors 104 transmits pressure at the period, T, e.g., in accordance with a predetermined operation of the tire monitors.

Unlike the example of FIG. 2, however, the representation 300 shows that a second transmission from the tire monitors may be varied in time. Specifically, the second transmission from the first tire monitor 104(1) is illustrated as being sent in accordance with a first offset, O₁. Similarly, the second transmission from the second tire monitor 104(2) is offset by a second offset, O₂, the second transmission from the third tire monitor 104(3) is offset by a third offset, O₃, and the second transmission from the fourth tire monitor 104(4) is offset by a fourth offset, O₄. In the illustrated example, each of the offsets corresponds to a different time. In one non-limiting example, the period, T, may correspond to 60 seconds. The first offset, O₁, may be 15 seconds, the second offset, O₂, may be 30 seconds, the third offset, O₃, may correspond to 45 seconds, and the fourth offset. O₄, may correspond to 60 seconds (e.g., no offset relative to the conventional processing. Of course these offset values are for example only.

In examples, each of the tire monitors 104 may receive commands from the tire pressure monitoring system 116 and/or other onboard components 134 with instructions to implement a respective offset, e.g., as an adjusted timing parameter. As also illustrated, the offsets facilitate spacing of the transmissions from each of the tire monitors 104, e.g., to reduce or eliminate interference and/or the potential for interference caused by overlapping transmissions. In the examples, the second transmission from each of the tire monitors may be an offset transmission, with transmissions of subsequent data being sent according to the predetermined period. T. The adjust timing parameters, e.g., the offsets, may vary based on at least one of the period, T, transmission timing information from the additional devices 202, and/or other factors. In some examples, the offsets may be determined by the timing determination component 132, e.g., according to some or all of the functioning discussed herein.

Although the example of FIG. 3 demonstrates the monitors reverting to a predetermined period, T, in some examples, subsequent timing intervals between transmissions may also be variable. For example, subsequent timing intervals may be adjusted to eliminate bandwidth competition with the additional devices.

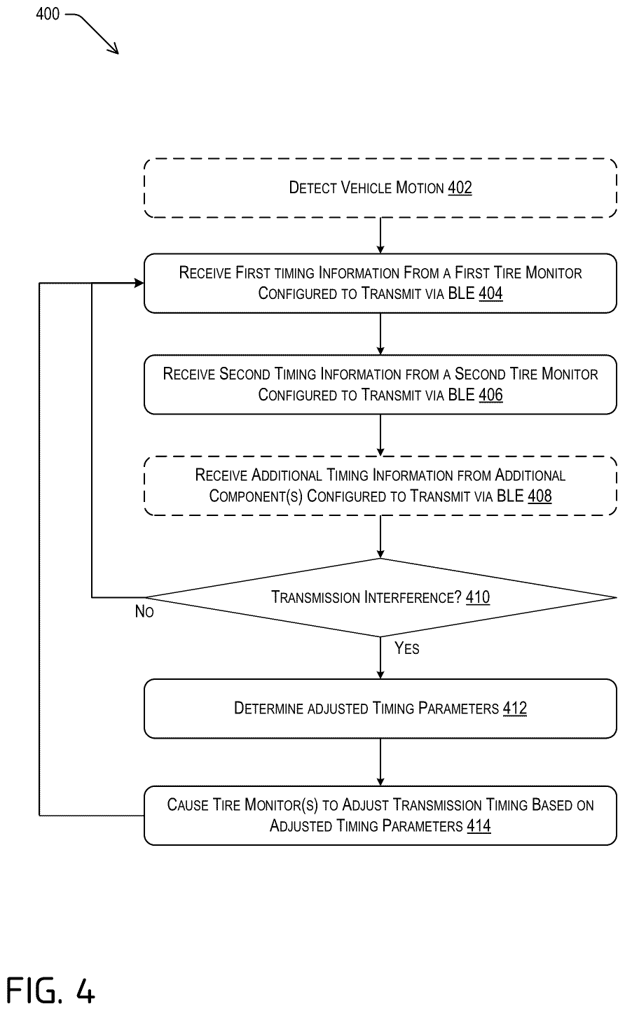

FIG. 4 is a flowchart showing an example process 400 for determining and scheduling TPM transmission timings in vehicles, in accordance with aspects of the disclosure. The process is illustrated as logical flow graphs, with each operation representing a sequence of operations that can be implemented in software, hardware, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

The various illustrative operations, components, and systems described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

At an operation 402, the process 400 includes, optionally, detecting vehicle motion. In some implementations, individual tire monitors on a vehicle can include a motion-sensing component, which may include a shock sensor, an accelerometer, a gyroscope, or the like. In other implementations, one or more motion sensors may be disposed on the vehicle, e.g., to detect motion of the vehicle body. The operation 402 may include receiving information from one or more of these sensors that the vehicle is moving. In some instances, detected motion (e.g., detected either at the tire monitors or elsewhere on the vehicle) may trigger the tire monitors to enter an active or driving state in which the tire monitors sample and transmit pressure data at a predetermined frequency.

At an operation 404, the process 400 includes receiving first timing information from a first tire monitor configured to transmit via BLE. As described herein, the tire monitors 104 may be configured to transmit information, e.g., tire pressure information, at a predetermined frequency. The operation 404 can include receiving an initial transmission from the first tire monitor and determining, from the transmission, a time associated with the transmission. For instance, the time may be determined from one or more timestamps, which may be associated with the transmission, e.g., as metadata, a tag, or the like. In other examples, the operation 404 can include determining multiple times for the same transmission, e.g., a start time for the transmission and an end time for the transmission. The operation 404 may also include receiving a number of transmissions from the first tire monitor, e.g., with each having an associated time. For example, the transmission timings can be received by an onboard component 134 and/or other component of the vehicle 100, including, without limitation, another of the tire monitors. As noted above, the operation 404 may be performed upon commencement of motion of the vehicle, although in other examples, the operation 404 may be performed when the vehicle is stationary.

At an operation 406, the process 400 includes receiving second timing information from a second tire monitor configured to transmit via BLE. As described herein, the tire monitors 104 may be configured to transmit information, e.g., tire pressure information, at a predetermined frequency. The operation 406 can include receiving an initial transmission from the second tire monitor and determining, from the transmission, a time associated with the transmission. For instance, the time may be determined from a timestamp, which may be associated with the transmission, e.g., as metadata, a tag, or the like. In other examples, the operation 406 can include determining multiple times for the same transmission. e.g., a start time for the transmission and an end time for the transmission. In other examples, the operation 406 can include receiving a number of transmissions from the first tire monitor, e.g., with each having an associated time. For example, the transmission timings can be received by an onboard component 134 and/or other component of the vehicle 100, including, without limitation another of the tire monitors. As noted above, the operation 406 may be performed upon commencement of motion of the vehicle, although in other examples, the operation 406 may be performed when the vehicle is stationary.

At an operation 408, the process 400 includes, optionally, receiving additional timing information from additional component(s) configured to transmit via BLE. As described herein, vehicle systems may be configured to communicate with a number of devices, including but not limited to the onboard component(s) 134 and/or the remote device(s) 144. Without limitation, the operation 408 can also include receiving transmission timing information from additional tire monitors. In examples in which several devices transmit using the same communication protocol, e.g., BLE, bandwidth may be reduced, potentially leading to interference, clashing, or otherwise hindering communication. The operation 408 can include receiving transmission data from any additional devices that may impact bandwidth.

At an operation 410, the process 400 includes determining transmission interference. For example, the operation 410 may include comparing the timings of the transmissions of the various devices, e.g., the timings received at the operations 404, 406, 408, and determining whether there is interference between any of the communications. In some examples, the operation 410 can determine whether there is actual interference or whether there is likely to be interference or a potential for interference. For instance, the operation 410 can include determining whether two transmissions occur within a threshold time of each other, e.g., within 2 seconds of each other, or the like. In one non-limiting example, the operation 410 can include determining, from the information received at the operation 404 and the information received at the operation 406, that the first tire monitor 104(1) and the second tire monitor 104(2) are configured to transmit data at one-minute intervals, but the respective transmissions from the first tire monitor 104(1) and the second tire monitor 104(2) are within one second of each other. In this example, the operation 410 may conclude that there is likely transmission interference, e.g., because of the close proximity in time of the transmissions. The operation 410 can also include consideration of the timing information optionally received at the operation 408, e.g., from one or more additional tire monitors and/or other devices operating under the same communication protocol.

If, at the operation 410 it is determined that there is no transmission interference (e.g., “NO” at the operation 410), the process 400 may return to the operation 404, e.g., to continue to monitor transmission timings for potential (or actual) interference. For instance, although interference may not exist at a certain time, timings associated with the transmissions may drift or otherwise change over time. For example, clock drift at a tire monitor may cause transmission times from that tire monitor to be altered. Moreover, additional devices that may be configured to transmit over the protocol may be introduced to the vehicle. Without limitation, a passenger may enter the vehicle with a BLE-enabled device that may pair to or otherwise communicate with a system of the vehicle. In further examples, a device may be introduced that is configured to communicate with the vehicle using OTA technology, e.g., to update one or more vehicle systems. In examples, this interaction could itself increase communication traffic. Moreover, the updates may result in changes to the timing of any (or all) of the other components of the system, e.g., in instances in which the update requires one or more components to reboot or the like. Thus, the process 400 can be an active process that continues to look for interference.

If, at the operation 410 it is determined that there is transmission interference (e.g., “YES” at the operation 410), at an operation 412 the process 400 includes determining adjusted timing parameters. For example, and as discussed herein, the timing determination component 132 can receive transmission timing information from the various tire monitors and/or other devices, and determine one or more adjusted timings for the monitors/devices. For example, the adjusted timings may be determined to maximize a time between different transmissions. In one non-limiting example, the operation 410 may determine that transmissions from four tire monitors that are configured to transmit every 60 second should be staggered by 15 seconds. Thus, a transmission from the second tire monitor may occur 15 seconds after a transmission from the first tire monitor, a transmission from the third tire monitor may occur 15 seconds after the transmission from the second tire monitor, a transmission from the fourth tire monitor may occur 15 seconds after the transmission from the third tire monitor, a next transmission from the first tire monitor will occur 15 seconds after the transmission from the fourth tire monitor, and so forth. The operation 412 may also include determining transmission timings based at least in part on impact to bandwidth. e.g., based at least in part on the amount of data to be transmitted. In some examples, two or more transmissions may be allowed to overlap or interfere, e.g., if the collective impact of the transmission(s) will not significantly reduce bandwidth

At an operation 414, the process 400 includes causing the tire monitor(s) to adjust transmission timing based on the adjusted timing parameters. For example, the operation 414 can include generating instructions for the tire monitors 104 to implement the tire sensor transmission timings. Because the tire monitors are configured to communication via a bidirectional communication protocol, e.g., BLE, the tire monitors can receive instructions from a computing system, e.g., the computing system that performs the process 400. In response to receiving the instructions, the tire monitor transmission timing may be updated. For instance, the tire monitor receiving the instructions may restart transmission (e.g., after a delay or the like) to begin transmission according to the adjusted timing parameters. In some examples, the TPM system 116 may adjust the tire monitors 104 transmission timings directly. Also, in examples, the tire monitors 104 may adjust each associated transmission timing directly. At an operation 408, the process 400 may include an onboard component 134 (e.g., vehicle electronic control unit) transmitting instructions to the tire monitors 104 during a BLE receive window. For example, when vehicle 100 is stationary, a BLE receive window opens immediately after the tire monitors 104 have transmitted TPM data. During this BLE receive window, an onboard component 134 (e.g., vehicle control unit) transmits the generated data to inform the tire monitors 104 and/or sensors of the updated transmission timing, giving control of the TPM system 116 to the vehicle 100.

Although the operation 414 contemplates adjusting timings of the tire monitors, in other examples timings associated with other of the devices may be adjusted. For example, the process may be carried out at a computing system, such as an executive control unit, that may be configured to control other aspects of the vehicle, including one or more of the onboard component(s) 134.

Upon updating the timings at the respective tire monitors, the tire monitors may also be configured to update sampling timing. For instance, the tire monitors may be (re) configured to sample tire pressure at times corresponding to the transmission timings, e.g., such that the transmitted tire pressure data is up-to-date or “fresh” data.

After completion of the operation 414, the process 400 can return to the operation 404. e.g., to continue to receive transmission timing information and look for actual or potential interference. For instance, although the process 400 may have instructed updated or adjusted transmission timings, one or more of the monitors may have failed to reconfigure according to the adjusted timing parameters. For example, failing to update the timing of the tire monitor may be an indication that the tire monitor is defective. Thus, continuing to perform the process 400 can effectively act as a check that the timings were properly updated, that components are functioning properly, and/or that the adjusted timing parameters were correctly determined.

Moreover, by actively monitoring transmission timings, changes in network traffic can also be readily detected and accounted for. For instance, timings associated with the transmissions may drift or otherwise change over time. For example, clock drift at a tire monitor may cause transmission times from that tire monitor to be altered. Moreover, additional devices that may be configured to transmit over the protocol may be introduced to the vehicle. Without limitation, a passenger may enter the vehicle with a BLE-enabled device that may pair to or otherwise communicate with a system of the vehicle. In further examples, a device may be introduced that is configured to communicate with the vehicle using OTA technology, e.g., to update one or more vehicle systems. In examples, this interaction could itself increase communication traffic. Moreover, the updates may result in changes to the timing of any (or all) of the other components of the system, e.g., in instances in which the update requires one or more components to reboot or the like. Thus, the process 400 can be an active process that continues to look for interference, as well as to identify potentially defective sensors

As noted above, aspects of this disclosure may also reduce or eliminate the risk of bandwidth overload resulting from OTA updates. Such updates could potentially conflict with set tire monitor 104 transmission timings and could heavily strain or overload the available BLE bandwidth. For instance, if the OTA updates produce BLE transmission timings in conjunction with all of the tire monitor transmission timings, there is a potential for bandwidth overload and/or competition that could impact the vehicle's efficacy, place the vehicle in noncompliance with legal regulations and/or creating hazardous conditions.

As apparent from the foregoing, aspects of this disclosure provide improved detection and remedying of unsafe BLE transmission timing conditions associated with competing transmission timings across the vehicle's systems. For example, aspects of this disclosure can ensure that a vehicle owner, driver, passenger, or other person associated with a vehicle can receive important information about the vehicle, such as tire pressure information, regardless of an amount of BLE traffic. Previous TPM system transmission timing schemes often designated static delays and sequential ordering of all the tire monitors that did not account for other onboard BLE transmitting systems, potential impacts of OTA updates, clock drift within individual tire monitors and/or problematic, close timing proximities amongst the individual transmission from the tire monitors.

Aspects of this disclosure may also provide improved detection of unsafe driving conditions associated with tire pressure anomalies. For example, aspects of this disclosure may provide tire information at a faster rate, e.g., by mitigating adverse effects that may result from overloading communication channels, such as BLE channels, which may more readily identify tire pressure anomalies and/or other tire-related issues.

As used in any embodiment described herein, the term “circuitry” may comprise, for example, singly or in any combination, hardwired circuitry, programmable circuitry, state machine circuitry, and/or firmware that stores instructions executed by programmable circuitry. It should be understood at the outset that any of the operations and/or operative components described in any embodiment or embodiment herein may be implemented in software, firmware, hardwired circuitry and/or any combination thereof.

The terminology used herein is for the purpose of describing particular embodiments and is not intended to be limiting of the disclosure. As used herein, the singular forms “a”, “an” and “the” are intended to include the plural forms as well, unless the context clearly indicates otherwise. It will be further understood that the terms “comprises” and/or “comprising.” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

While the subject technology has been described with respect to preferred embodiments, those skilled in the art will readily appreciate that various changes and/or modifications can be made to the subject technology without departing from the spirit or scope of the subject technology. For example, each claim may depend from any or.

What is claimed is:

1. A vehicle comprising:
a plurality of tires;
a first tire monitor associated with a first tire of the plurality of tires, the first tire monitor including a first pressure sensing component for generating first tire pressure data associated with the first tire and a first transmitter for transmitting the first tire pressure data using Bluetooth Low Energy (BLE);
a second tire monitor associated with a second tire of the plurality of tires, the second tire monitor including a second pressure sensing component for generating second tire pressure data associated with the second tire and a second transmitter for transmitting the second tire pressure data using BLE; and
a computing system configured to perform operations comprising:
receiving first timing information associated with transmission of the first pressure data from the first tire monitor;
receiving second timing information associated with transmission of the second pressure data from the second tire monitor;
determining, based at least in part on the first timing information and the second timing information, a transmission interference;
determining, based at least in part on the determining the transmission interference, adjusted timing parameters for at least one of the first tire monitor or the second tire monitor; and
transmitting, to the at least one of the first tire monitor or the second tire monitor, a signal to cause the at least one of the first tire monitor or the second tire to adjust a timing associated with transmission of the first pressure data or transmission of the second pressure data according to the adjusted timing parameters.

2. The vehicle of claim 1, wherein the determining the transmission interference comprises:
determining, based at least in part on the first timing information, one or more first transmission times associated with the first pressure data;
determining, based at least in part on the second timing information, one or more second transmission times associated with the second pressure data; and
determining the transmission interference based at least in part on one of the first transmission times being within a threshold time of one of the second transmission times.

3. The vehicle of claim 2, wherein the determining the adjusted timing parameters comprises determining at least one of an altered first transmission time, offset relative to the first transmission times, or an altered second transmission time, offset relative to the second transmission times.

4. The vehicle of claim 3, the operations further comprising:
determining the at least one of the altered first transmission time or the altered second transmission time to maximize an offset between instances of the first transmission times and instances of the second transmission times.

5. The vehicle of claim 3, the operations further comprising:
receiving additional timing information associated with transmission of data using BLE; and
determining the at least one of the altered first transmission time or the altered second transmission time based at least in part on the additional timing information,
wherein the at least one of the altered first transmission time or the altered second transmission time is determined to avoid interference with the transmission of the data using BLE.

6. The vehicle of claim 5, wherein the receiving the additional timing information comprises receiving the additional timing information from a computing component configured to provide updated information to the vehicle via over the air technology.

7. The vehicle of claim 1, the operations further comprising:
receiving, from a computing component configured to transmit data using BLE, third timing information associated with transmission of the data;
wherein the determining the transmission interference is based at least in part on the third timing information.

8. The vehicle of claim 1, wherein the transmitting the signal comprises transmitting the signal using BLE.

9. The vehicle of claim 1, wherein:
the at least one of the first tire monitor or the second tire monitor adjusts the timing associated with the transmission of the first pressure data or transmission of the second pressure data; and
the at least one of the first tire monitor or the second tire monitor adjusts one or more sample timings based at least in part on the signal.

10. The vehicle of claim 1, further comprising:
a motion sensor configured to detect motion of the vehicle,
the operations further comprising requesting the first timing information and the second timing information in response to the motion sensor detecting motion of the vehicle.

11. A method comprising:
receiving, via a BLE transmission and from a tire monitor on a vehicle, first timing information associated with transmission of pressure data generated by the tire monitor, the tire pressure monitor being configured to transmit the pressure data using BLE;
receiving, from a computing device onboard the vehicle, second timing information associated with transmission of data from the computing device, the computing device being configured to transmit the data using BLE;
determining, based at least in part on the first timing information and the second timing information, a potential transmission interference; and
transmitting, to the tire monitor, a signal to cause the tire monitor to adjust timing associated with transmission of the pressure data, wherein the tire monitor is configured to adjust the timing.

12. The method of claim 11, wherein the determining the potential transmission interference comprises:
determining, based at least in part on the first timing information, one or more first transmission times associated with the first pressure data;
determining, based at least in part on the second timing information, one or more second transmission times associated with the data; and
determining one of the first transmission times is within a threshold time of one of the second transmission times.

13. The method of claim 12, wherein:
the tire monitor is a first tire monitor associated with a first tire of the vehicle, and
the computing device is associated with a second tire monitor associated with a second tire of the vehicle.

14. The method of claim 11, further comprising:
receiving motion data indicative of movement of the vehicle; and
requesting, from the tire monitor and based at least in part on the receiving the motion data, the first timing information,
wherein the receiving the first timing information is in response to the requesting the first timing information.

15. The method of claim 11, further comprising:
determining a transmission timing offset for the tire monitor,
wherein the transmitting the signal comprises transmitting a signal that causes the tire monitor to implement the timing offset for a transmission from the tire monitor.

16. A tire pressure monitoring system, comprising:
a first tire monitor associated with a first tire of a vehicle, the first tire monitor configured to generate and transmit first tire pressure data;
a second tire monitor associated with a second tire of the vehicle, the second tire monitor configured to generate and transmit second pressure data; and
a computing system configured to perform operations comprising:
receiving first timing information associated with transmission of the first pressure data by the first tire monitor;
receiving second timing information associated with transmission of the second pressure data by the second tire monitor;
determining, based at least in part on the first timing information and the second timing information, an interference between transmission of the first pressure data and transmission of the second pressure data; and
causing, based at least in part on determining the interference, the first tire monitor to alter a transmission time of the first pressure data.

17. The tire pressure monitoring system of claim 16, wherein:
the first tire monitor is configured to transmit the first pressure data using BLE; and
the second tire monitor is configured to transmit the second pressure data using BLE.

18. The tire pressure monitoring system of claim 16, the operations further comprising:
receiving motion data indicative of movement of the vehicle;
requesting, from the first tire monitor and based at least in part on the receiving the motion data, the first timing information; and
requesting, from the second tire monitor and based at least in part on the receiving the motion data, the second timing information.

19. The tire pressure monitoring system of claim 16, wherein the determining the interference comprises:
determining, based at least in part on the first timing information, one or more first transmission times associated with the first pressure data;
determining, based at least in part on the second timing information, one or more second transmission times associated with the second pressure data; and
determining the transmission interference based at least in part on one of the first transmission times being within a threshold time of one of the second transmission times.

20. The tire pressure monitoring system of claim 16, the operations further comprising:
determining an altered first transmission time, offset relative to the first transmission times,
wherein the causing the first tire monitor to alter the transmission time of the first pressure data comprises causing the first tire monitor to transmit the first pressure data at the altered first transmission time.
